(19) United States
(12) Patent Application Publication
(10) Pub. No.: US 2013/0080397 A1
(43) Pub. Date: Mar. 28, 2013

(54) DATABASE RESTORE USING INCREMENTAL BACKUPS IN REVERSE ORDER

(71) Applicants: Michael A. Payne, Archer, FL (US); Louis Beatty, Ormond Beach, FL (US)

(72) Inventors: Michael A. Payne, Archer, FL (US); Louis Beatty, Ormond Beach, FL (US)

(73) Assignee: SYMANTEC CORPORATION, Mountain View, CA (US)

(21) Appl. No.: 13/247,231

(22) Filed: Sep. 28, 2011

(51) Int. Cl. G06F 7/00; G06F 17/30

(52) U.S. Cl. 707/681; 707/679; 707/E17.007; 707/E17.044

(57) ABSTRACT

A full backup of a database is created at a first point in time. To restore the database to its state at a second point in time (after the full backup was created), a set of incremental backups, including the incremental backup that corresponds to the second point in time and incremental backups created between the first and second points in time, is used in reverse chronological order. For example, blocks in the full backup can be selectively overwritten with corresponding blocks from the incremental backups in reverse chronological order.

### BACKGROUND

By making a backup copy of an active database at a point in time, the database can be restored its state at that point in time if, for example, the database subsequently becomes corrupted or is lost. Initially, a full backup of the database is made, then incremental backups can be made to save changes that occurred after the full backup or after the most recent incremental backup were made.

To restore the database to the state it was in at a specified point in time, first the full backup is accessed, then blocks from the first incremental backup following the full backup are written to corresponding blocks in the full backup, then blocks from the next incremental backup are written to corresponding blocks in the full backup, and so on, until at last the incremental backup corresponding to the specified point in time is written to the full backup. Such a process can be time-consuming and inefficient if, for example, the same blocks change from one incremental backup to the next, because then the same blocks are written to over and over again as each incremental backup is written to the full backup.

### SUMMARY

According to embodiments of the present disclosure, a database can be restored faster and more efficiently. In general, each of the various embodiments disclosed herein utilizes the incremental backups in reverse chronological order. That is, the order in which the incremental backups are used is the opposite of the order in which they were created. Thus, instead of starting with the first incremental backup after a full backup and proceeding forward from there to restore a database to its state at a specified point in time, rather, the database is restored starting with the incremental backup that corresponds with the specified point in time, followed by an incremental backup that was created before that incremental backup, and so on.

In one embodiment, a full backup of a database is created at a first point in time. In this embodiment, the database can be restored to its state at a second point in time after the full backup was created as follows. A series of incremental backups, including the incremental backup that corresponds to the second point in time and also including incremental backups created between the first and second points in time, is accessed (to simplify the following discussion, the incremental backup corresponding to the second point in time may be referred to as the last incremental backup because it is the last time-wise backup in the set). Blocks in the full backup are then overwritten with corresponding blocks from the set of incremental backups, starting with the last incremental backup and continuing through the remaining incremental backups in the set in reverse chronological order. In this embodiment, blocks are overwritten only a single time during the restore operation; overwriting of blocks in the full backup is terminated when all blocks in the full backup that changed between the full backup and the last incremental backup are overwritten once. To accomplish this, blocks that are different between the full backup and the last incremental backup, and that are overwritten in the full backup during the restore operation, are tracked. For example, in one embodiment, change maps for the set of incremental backups are stored; a change map indicates blocks that are stored in a corresponding incremental backup. Using the change maps, a list of blocks that are different between the full backup and the last incremental backup can be generated. When a block of the full backup is overwritten, the entry in the list for that block is flagged. Blocks in the full backup continue to be overwritten until all entries in the list are flagged.

In another embodiment, the database can be restored to its state at a second point in time after a full backup is created at a first point in time, as follows. In contrast to the embodiment just described, in which blocks from the incremental backups are written to a full backup of the database, the incremental backup that corresponds to the second point in time (the “last incremental backup”) is written to a “restore database” that is essentially empty. Other incremental backups created between the creation of the full backup and the last incremental backup are also written to the restore database in reverse chronological order. Once the incremental backups have been written to the restore database, blocks from the full backup that correspond to empty blocks in the restore database are written to the restore database. In essence, instead of starting with the full backup and selectively overwriting blocks in the full backup with blocks from the incremental backups as in the embodiment described above, in this embodiment the incremental backups are written first to an empty database and then the full backup is used to complete the restored database.

In yet another embodiment, the database can be restored to its state at a second point in time after a full backup is created at a first point in time, as follows. In contrast to the embodiments described above, in which either a full backup of the database or an essentially empty version of a restore database is used as the foundation for the restore operation, the “active database” (the current version of the database) is used. That is, if the restore operation is initiated at a third point in time (after the second point in time), the incremental backup that corresponds to the second point in time (the “last incremental backup”) is written to the active database as it exists at the third point in time. Other incremental backups created between the creation of the full backup and the last incremental backup are also written to the active database in reverse chronological order. Once the incremental backups have been written to the restore database, blocks from the full backup that correspond to blocks in the active database that were not overwritten are written to the active database. In essence, in this embodiment, the active database at the third point in time is updated first with the incremental backups and then with the full backup.

In summary, embodiments according to the present disclosure restore a database by working through incremental backups in reverse chronological order (in the order opposite that in which they were created). Accordingly, as will be described in greater detail in the discussion to follow, the number of blocks that are written during the restore operation is reduced. Consequently, the restore operation can be accomplished quicker and more efficiently, using less computational resources.

These and other objects and advantages of the various embodiments of the present disclosure will be recognized by those of ordinary skill in the art after reading the following detailed description of the embodiments that are illustrated in the various drawing figures.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a block diagram of an example of a computing system capable of implementing embodiments according to the present disclosure.

FIG. 2 is a block diagram of an example of a network architecture capable of implementing embodiments according to the present disclosure.

FIG. 3 represents an example of a file management system upon which embodiments according to the present disclosure can be implemented.

FIG. 4 illustrates a process for creating database backups that can be utilized with embodiments according to the present disclosure.

FIG. 5 illustrates an example of a process for restoring a database in an embodiment according to the present disclosure.

FIG. 6 illustrates an example of a process for restoring a database in another embodiment according to the present disclosure.

FIG. 7 illustrates an example of a process for restoring a database in yet another embodiment according to the present disclosure.

FIG. 8 is a flowchart of a computer-implemented process for restoring a database according to an embodiment of the present disclosure.

FIG. 9 is a flowchart of a computer-implemented process for restoring a database according to another embodiment of the present disclosure.

FIG. 10 is a flowchart of a computer-implemented process for restoring a database according to yet another embodiment of the present disclosure.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

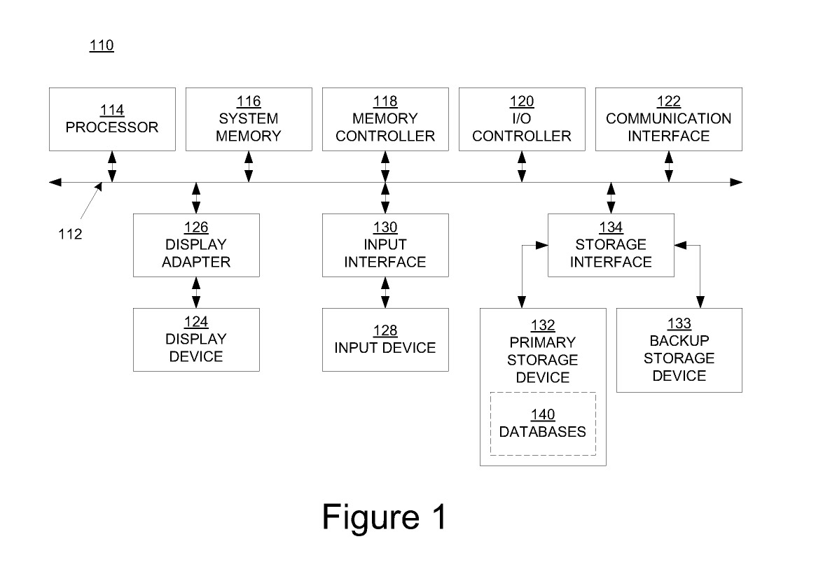

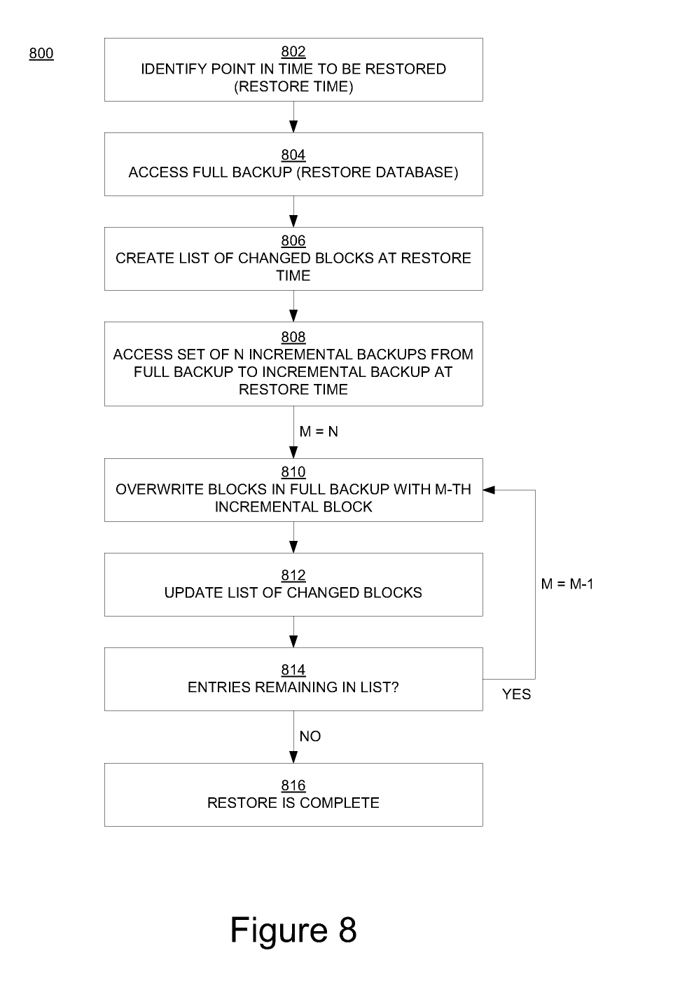

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “creating,” “restoring,” “accessing,” “writing,” “overwriting,” “storing,” “comparing,” “skipping,” “generating,” “flagging,” “initiating,” “indicating,” “tracking,” “freezing,” or the like, refer to actions and processes (e.g., flowcharts 800, 900, and 1000 of FIGS. 8, 9, and 10, respectively) of a computer system or similar electronic computing device or processor (e.g., system 110 of FIG. 1). The computer system or similar electronic computing device manipulates and transforms data represented as physical (electronic) quantities within the computer system memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared and other wireless media. Combinations of any of the above can also be included within the scope of computer-readable media.

FIG. 1 is a block diagram of an example of a computing system 110 capable of implementing embodiments of the present disclosure. The computing system 110 broadly represents any single or multi-processor computing device or system capable of executing computer-readable instructions. Examples of the computing system 110 include, without limitation, workstations, laptops, client-side terminals, servers, distributed computing systems, handheld devices, or any other computing system or device. In its most basic configuration, the computing system 110 may include at least one processor 114 and a system memory 116.

The processor 114 generally represents any type or form of processing unit capable of processing data or interpreting and executing instructions. In certain embodiments, the processor 114 may receive instructions from a software application or module. These instructions may cause the processor 114 to perform the functions of one or more of the example embodiments described and/or illustrated herein. For example, the processor 114 may perform and/or be a means for performing, either alone or in combination with other elements, one or more of the identifying, determining, using, implementing, translating, tracking, receiving, moving, and providing described herein. The processor 114 may also perform and/or be a means for performing any other steps, methods, or processes described and/or illustrated herein.

The system memory 116 generally represents any type or form of volatile or non-volatile storage device or medium capable of storing data and/or other computer-readable instructions. Examples of system memory 116 include, without limitation, RAM, ROM, flash memory, or any other suitable memory device. Although not required, in certain embodiments the computing system 110 may include both a volatile memory unit (such as, for example, system memory 116) and a non-volatile storage device (such as, for example, the primary storage device 132).

The computing system 110 may also include one or more components or elements in addition to the processor 114 and the system memory 116. For example, in the embodiment of FIG. 1, the computing system 110 includes a memory controller 118, an input/output (I/O) controller 120, and a communication interface 122, each of which may be interconnected via a communication infrastructure 112. The communication infrastructure 112 generally represents any type or form of infrastructure capable of facilitating communication between one or more components of a computing device. Examples of communication infrastructure 112 include, without limitation, a communication bus (such as an Industry Standard Architecture (ISA), Peripheral Component Interconnect (PCI), PCI Express (PCIe), or similar bus) and a network.

The memory controller 118 generally represents any type or form of device capable of handling memory or data or controlling communication between one or more components of the computing system 110. For example, the memory controller 118 may control communication between the processor 114, system memory 116, and the I/O controller 120 via the communication infrastructure 112. Memory controller may perform and/or be a means for performing, either alone or in combination with other elements, one or more of the operations or features described herein.

The I/O controller 120 generally represents any type or form of module capable of coordinating and/or controlling the input and output functions of a computing device. For example, the I/O controller 120 may control or facilitate transfer of data between one or more elements of the computing system 110, such as the processor 114, system memory 116, the communication interface 122, the display adapter 126, the input interface 130, and the storage interface 134. The I/O controller 120 may be used, for example, to perform and/or be a means for performing, either alone or in combination with other elements, one or more of the operations described herein. The I/O controller 120 may also be used to perform and/or be a means for performing other operations and features set forth in the instant disclosure.

The communication interface 122 broadly represents any type or form of communication device or adapter capable of facilitating communication between the example computing system 110 and one or more additional devices. For example, the communication interface 122 may facilitate communication between the computing system 110 and a private or public network including additional computing systems. Examples of the communication interface 122 include, without limitation, a wired network interface (such as a network interface card), a wireless network interface (such as a wireless network interface card), a modem, and any other suitable interface. In one embodiment, the communication interface 122 provides a direct connection to a remote server via a direct link to a network, such as the Internet. The communication interface 122 may also indirectly provide such a connection through, for example, a local area network (such as an Ethernet network), a personal area network, a telephone or cable network, a cellular telephone connection, a satellite data connection, or any other suitable connection.

The communication interface 122 may also represent a host adapter configured to facilitate communication between the computing system 110 and one or more additional network or storage devices via an external bus or communications channel. Examples of host adapters include, without limitation, Small Computer System Interface (SCSI) host adapters, Universal Serial Bus (USB) host adapters, IEEE (Institute of Electrical and Electronics Engineers) 1394 host adapters, Serial Advanced Technology Attachment (SATA) and External SATA (eSATA) host adapters, Advanced Technology Attachment (ATA) and Parallel ATA (PATA) host adapters, Fibre Channel interface adapters, Ethernet adapters, or the like. The communication interface 122 may also allow the computing system 110 to engage in distributed or remote computing. For example, the communication interface 122 may receive instructions from a remote device or send instructions to a remote device for execution. The communication interface 122 may perform and/or be a means for performing, either alone or in combination with other elements, one or more of the operations disclosed herein. The communication interface 122 may also be used to perform and/or be a means for performing other operations and features set forth in the instant disclosure.

As illustrated in FIG. 1, the computing system 110 may also include at least one display device 124 coupled to the communication infrastructure 112 via a display adapter 126. The display device 124 generally represents any type or form of device capable of visually displaying information forwarded by the display adapter 126. Similarly, the display adapter 126 generally represents any type or form of device configured to forward graphics, text, and other data from the communication infrastructure 112 (or from a frame buffer, as known in the art) for display on the display device 124.

As illustrated in FIG. 1, the computing system 110 may also include at least one input device 128 coupled to the communication infrastructure 112 via an input interface 130. The input device 128 generally represents any type or form of input device capable of providing input, either computer-generated or human-generated, to the computing system 110. Examples of the input device 128 include, without limitation, a keyboard, a pointing device, a speech recognition device, or any other input device. In one embodiment, the input device 128 may perform and/or be a means for performing, either alone or in combination with other elements, one or more of the operations disclosed herein. The input device 128 may also be used to perform and/or be a means for performing other operations and features set forth in the instant disclosure.

As illustrated in FIG. 1, the computing system 110 may also include a primary storage device 132 and a backup storage device 133 coupled to the communication infrastructure 112 via a storage interface 134. The storage devices 132 and 133 generally represent any type or form of storage device or medium capable of storing data and/or other computer-readable instructions. For example, the storage devices 132 and 133 may be a magnetic disk drive (e.g., a so-called hard drive), a floppy disk drive, a magnetic tape drive, an optical disk drive, a flash drive, or the like. The storage interface 134 generally represents any type or form of interface or device for transferring data between the storage devices 132 and 133 and other components of the computing system 110.

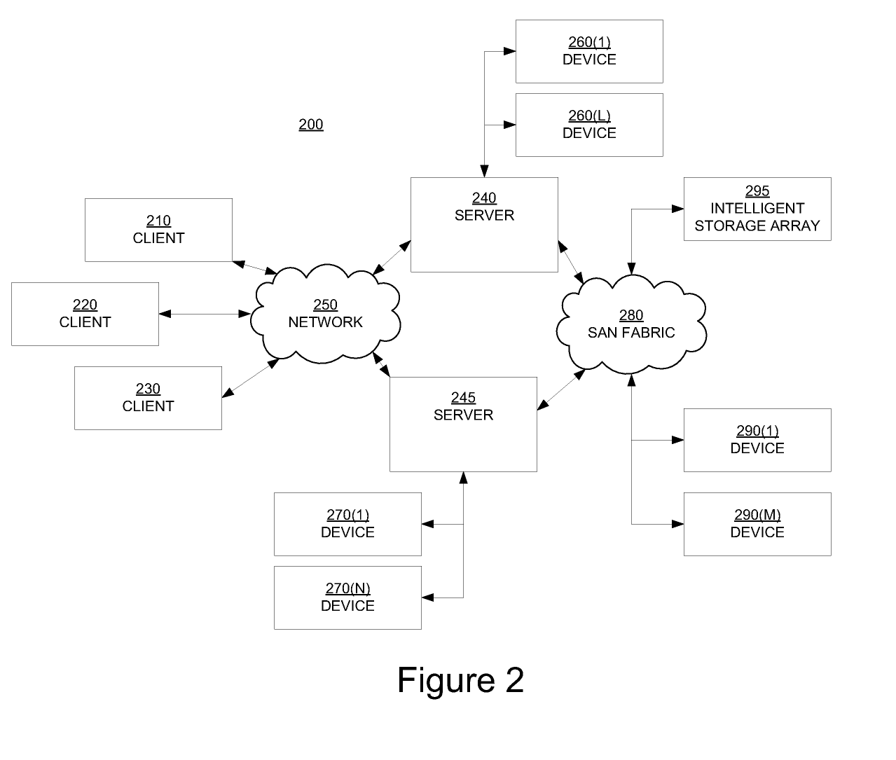

In one example, the databases 140 may be stored in the primary storage device 132. The databases 140 may represent portions of a single database or computing device or a plurality of databases or computing devices. For example, the databases 140 may represent (be stored on) a portion of computing system 110 and/or portions of the example network architecture 200 in FIG. 2 (below). Alternatively, the databases 140 may represent (be stored on) one or more physically separate devices capable of being accessed by a computing device, such as the computing system 110 and/or portions of the network architecture 200. In one embodiment, the databases 140 are Structured Query Language (SQL) databases.

Continuing with reference to FIG. 1, the storage devices 132 and 133 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. The storage devices 132 and 133 may also include other similar structures or devices for allowing computer software, data, or other computer-readable instructions to be loaded into the computing system 110. For example, the storage devices 132 and 133 may be configured to read and write software, data, or other computer-readable information. The storage devices 132 and 133 may also be a part of the computing system 110 or may be separate devices accessed through other interface systems.

The storage devices 132 and 133 may be used to perform, and/or be a means for performing, either alone or in combination with other elements, one or more of the operations disclosed herein. The storage devices 132 and 133 may also be used to perform, and/or be a means for performing, other operations and features set forth in the instant disclosure.

Many other devices or subsystems may be connected to the computing system 110. Conversely, all of the components and devices illustrated in FIG. 1 need not be present to practice the embodiments described herein. The devices and subsystems referenced above may also be interconnected in different ways from that shown in FIG. 1. The computing system 110 may also employ any number of software, firmware, and/or hardware configurations. For example, the example embodiments disclosed herein may be encoded as a computer program (also referred to as computer software, software applications, computer-readable instructions, or computer control logic) on a computer-readable medium.

The computer-readable medium containing the computer program may be loaded into computing system 110. All or a portion of the computer program stored on the computer-readable medium may then be stored in system memory 116 and/or various portions of the storage devices 132 and 133. When executed by the processor 114, a computer program loaded into the computing system 110 may cause the processor 114 to perform and/or be a means for performing the functions of the example embodiments described and/or illustrated herein. Additionally or alternatively, the example embodiments described and/or illustrated herein may be implemented in firmware and/or hardware. For example, the computing system 110 may be configured as an application specific integrated circuit (ASIC) adapted to implement one or more of the embodiments disclosed herein.

FIG. 2 is a block diagram of an example of a network architecture 200 in which client systems 210, 220, and 230 and servers 240 and 245 may be coupled to a network 250. The client systems 210, 220, and 230 generally represent any type or form of computing device or system, such as the computing system 110 of FIG. 1.

Similarly, the servers 240 and 245 generally represent computing devices or systems, such as application servers or database servers, configured to provide various database services and/or run certain software applications. The network 250 generally represents any telecommunication or computer network including, for example, an intranet, a wide area network (WAN), a local area network (LAN), a personal area network (PAN), or the Internet.

As illustrated in FIG. 2, one or more storage devices 260(1)-(L) may be directly attached to the server 240. Similarly, one or more storage devices 270(1)-(N) may be directly attached to the server 245. The storage devices 260(1)-(L) and storage devices 270(1)-(N) generally represent any type or form of storage device or medium capable of storing data and/or other computer-readable instructions. The storage devices 260(1)-(L) and storage devices 270(1)-(N) may represent network-attached storage (NAS) devices configured to communicate with the servers 240 and 245 using various protocols, such as Network File System (NFS), Server Message Block (SMB), or Common Internet File System (CIFS).

The servers 240 and 245 may also be connected to a storage area network (SAN) fabric 280. The SAN fabric 280 generally represents any type or form of computer network or architecture capable of facilitating communication between storage devices. The SAN fabric 280 may facilitate communication between the servers 240 and 245 and the storage devices 290(1)-(M) and/or an intelligent storage array 295. The SAN fabric 280 may also facilitate, via the network 250 and the servers 240 and 245, communication between the client systems 210, 220, and 230 and the storage devices 290(1)-(M) and/or intelligent storage array 295 in such a manner that the devices 290(1)-(M) and the array 295 appear as locally attached devices to the client systems 210, 220, and 230. As with the storage devices 260(1)-(L) and the storage devices 270(1)-(N), the storage devices 290(1)-(M) and the intelligent storage array 295 generally represent any type or form of storage device or medium capable of storing data and/or other computer-readable instructions.

With reference to the computing system 110 of FIG. 1, a communication interface, such as communication interface 122, may be used to provide connectivity between each client system 210, 220, and 230 and the network 250. The client systems 210, 220, and 230 may be able to access information on the server 240 or 245 using, for example, a Web browser or other client software. Such software may allow the client systems 210, 220, and 230 to access data hosted by the server 240, server 245, storage devices 260(1)-(L), storage devices 270(1)-(N), storage devices 290(1)-(M), or intelligent storage array 295. Although FIG. 2 depicts the use of a network (such as the Internet) for exchanging data, the embodiments described herein are not limited to the Internet or any particular network-based environment.

Returning to FIG. 2, in one embodiment, all or a portion of one or more of the example embodiments disclosed herein are encoded as a computer program and loaded onto and executed by the server 240, server 245, storage devices 260(1)-(L), storage devices 270(1)-(N), storage devices 290(1)-(M), intelligent storage array 295, or any combination thereof. All or a portion of one or more of the example embodiments disclosed herein may also be encoded as a computer program, stored in the server 240, run by the server 245, and distributed to the client systems 210, 220, and 230 over the network 250. Accordingly, the network architecture 200 may perform and/or be a means for performing, either alone or in combination with other elements, one or more of the operations disclosed herein. The network architecture 200 may also be used to perform and/or be a means for performing other operations and features set forth in the instant disclosure.

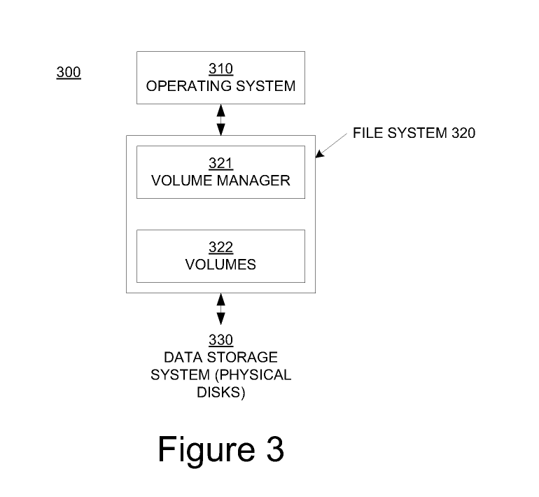

With reference to FIG. 3, a file management system 300 includes an operating system 310 and a file system 320 coupled to a physical data storage system 330. The file system 320 includes a volume manager 321 that operates as a subsystem between the operating system 310 and one or more volumes 322 of data (blocks of data) that are stored in the data storage system 330. The data storage system 330 may include physical storage devices such as an array of physical disks, LUNs (SCSI logical units), or other types of hardware that are used to store data. The volume manager 321 overcomes restrictions associated with the physical storage devices by providing a logical volume management layer that allows data to be spread across multiple physical disks within a disk array (not shown) in a manner that is transparent to the operating system 310. Each of the volumes 322 can retrieve data from one or more of the physical storage devices, and the volumes 322 are accessed by file systems, databases, and other applications in the same way that physical storage devices are accessed.

The file system 310 can be any database application for managing databases, such as but not limited to ORACLE DATABASE, a SQL (Structured Query Language) server, or MICROSOFT ACCESS. As noted previously herein, embodiments according to the present invention pertain to restoring databases (e.g., databases 140 of FIG. 1) managed by the file system 310. The restore operation can be performed using an application for creating snapshots and backup copies of the databases, such as MICROSOFT's Volume Snapshot Service (VSS).

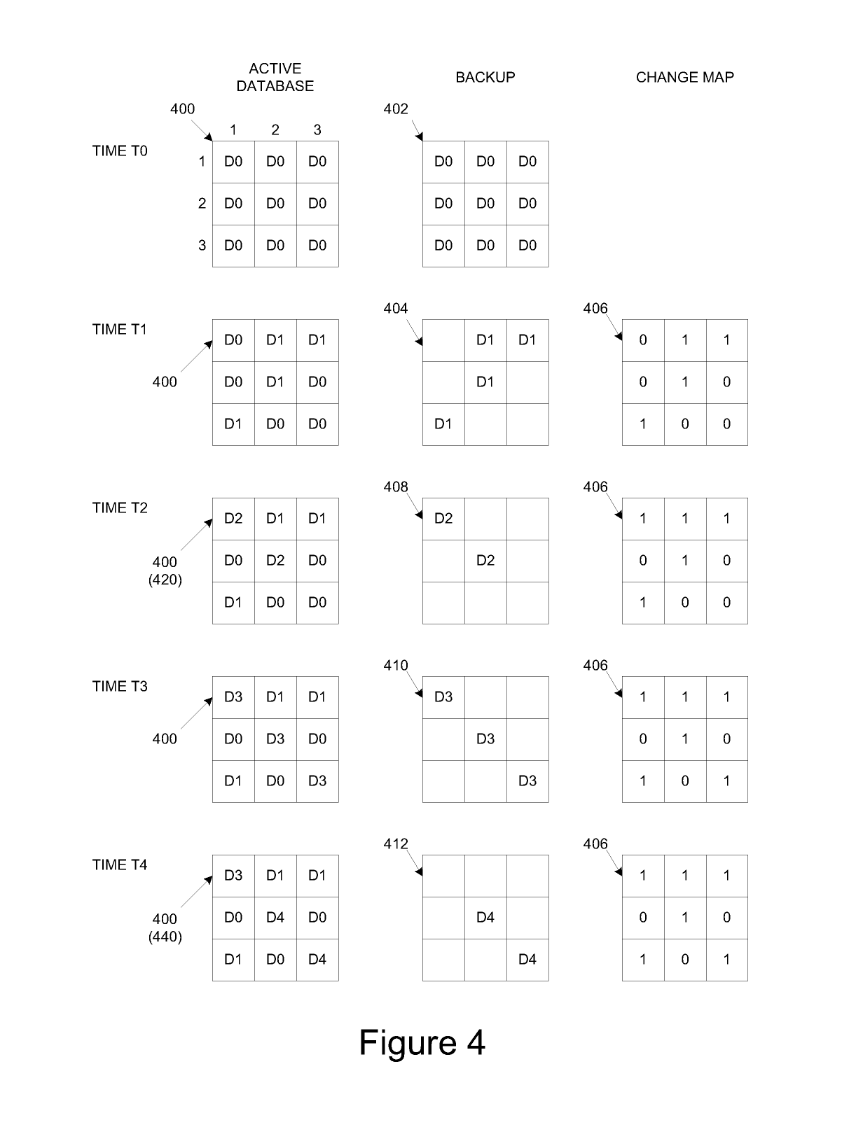

A process for creating database backups is illustrated in FIG. 4. In the example of FIG. 4, a portion of a database 400 is represented as nine data blocks. In the example of FIG. 4, the data blocks are identified using an (x,y) coordinate system; for example, the upper left block is identified as block (1,1) and the upper right block is identified as (1,3). The database 400 may be referred to herein as the “active database” or “live database.”

Time T0 corresponds to any point in the lifetime of the database 400, not necessarily the time at which the database is created. At time T0, each block of the database 400 includes data D0. Not all of the blocks necessarily contain the same data; “D0” simply refers to the data in a block at time T0. At time T0, a full backup copy 402 of the database 400 is made.

At time T1, the active database 400 has been modified and now includes data D1 in blocks (1,2), (1,3), (2,2), and (3,1) in addition to the data D0 that is in the other blocks. At time T1, an incremental backup 404 is made. The incremental backup 404 includes only a copy of the data blocks that changed since the last backup (e.g., the full backup at time T0). Also, in one embodiment, a change map 406 is made. The change map 406 can be used to track which of the data blocks changed and are included in the incremental backup 404. In the example of FIG. 4, the change map 406 is implemented as a bitmap in which a bit value of “1” indicates a block that has been changed; however, the change map can be implemented in other ways.

At time T2, the active database 400 has again been modified and now includes data D2 in blocks (1,1) and (2,2) in addition to the data D0 and D1 that is in the other blocks. At time T2, an incremental backup 408 is made. The incremental backup 408 includes only a copy of the data blocks that changed since the last backup (e.g., the incremental backup at time T1). Also, the change map 406 can be used to track the data blocks that are different between the full backup and the incremental backup at time T2. More specifically, the change map 406 can be updated to indicate which of the blocks have been changed since time T0. Alternatively, the change map can instead indicate only the blocks that changed between time T1 and time T2, in which case the change map at time T1 and the change map at time T2 can be subsequently combined if needed in order to indicate all of the blocks that changed between times T0 and T2.

At time T3, the active database 400 has again been modified and now includes data D3 in blocks (1,1), (2,2), and (3,3) in addition to the data D0, D1, and D2 that is in the other blocks. At time T3, an incremental backup 410 is made. The incremental backup 410 includes only a copy of the data blocks that changed since the last backup (e.g., the incremental backup at time T2). Also, the change map 406 is updated to indicate which of the blocks have been changed since time T0. If, instead, the change map is used to indicate only the blocks that changed from one backup to the next as mentioned above, then the change maps created at each backup can be subsequently combined if needed in order to indicate all of the blocks that changed between times T0 and T3.

At time T4, the active database 400 has again been modified and now includes data D4 in blocks (2,2), and (3,3) in addition to the data D0, D1, D2, and D3 that is in the other blocks. At time T4, an incremental backup 412 is made. The incremental backup 412 includes only a copy of the data blocks that changed since the last backup (e.g., the incremental backup at time T3). Also, the change map 406 is updated to indicate which of the blocks have been changed since time T0. If, instead, the change map is used to indicate only the blocks that changed from one backup to the next as mentioned above, then the change maps created at each backup can be combined to indicate all of the blocks that changed between times T0 and T4.

The process just described can continue until the next full backup is made, and from that point it can be repeated as many times as necessary.

Note that, according to embodiments of the present invention, it is not necessary to complete an incremental backup operation in order to update or create a change map. For example, after time T4, changes may be made to the active database 400 but, before those changes are captured in an incremental backup, a decision may be made to restore the database to a previous state. If the change map needs to be updated in order to perform that restore operation, then an incremental backup can be initiated and subsequently terminated once the change map is updated.

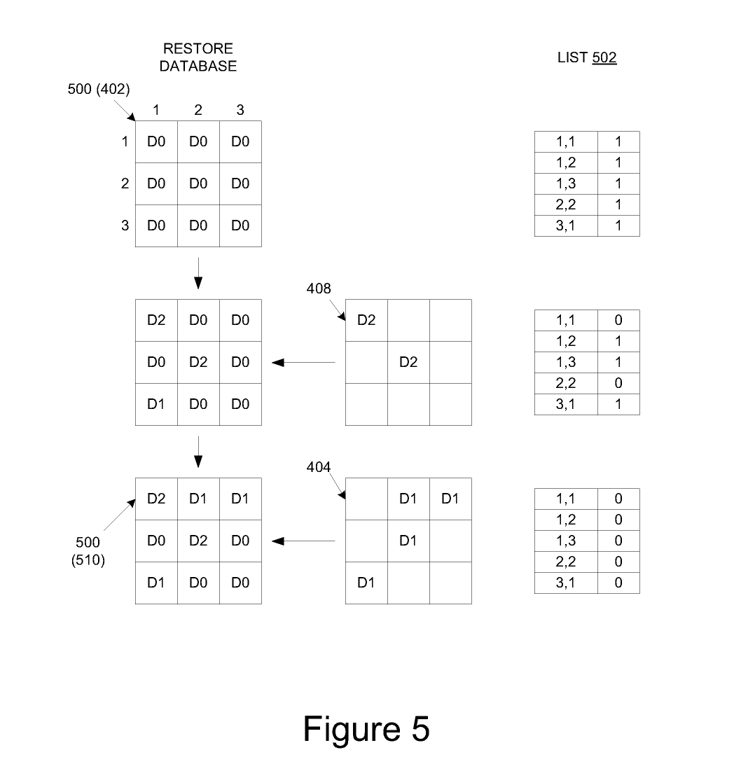

FIG. 5 illustrates an example of a process for restoring a database in an embodiment according to the present invention. In the example of FIG. 5, and with reference also to FIG. 4, the version of the database to be restored is the version 420 of the database 400 that existed at time T2. In this and the following examples, the restored version of the database is referred to as the “restore database,” and the point in time to which the database is to be restored is referred to as the “restore time.”

In the embodiment of FIG. 5, the full backup 402 is retrieved and used as the initial version of the restore database 500. In addition, the set of incremental backups between the full backup 400, up to and including the incremental backup (e.g., the incremental backup 408) corresponding to the restore time (e.g., time T2), is retrieved. For ease of discussion, the incremental backup corresponding to the restore time may be referred to as the last incremental backup, even though other incremental backups may have been subsequently made, because it is the last incremental backup in the set of incremental backups that is retrieved.

Also, a list 502 of blocks that changed between time T0 and the restore time is created. The list 502 can be created using the change map 406 for the incremental backup corresponding to the restore time. The change map 406 may itself be used as the list 502.

The initial version of the restore database 500 is first overwritten with the blocks from the last incremental backup (the incremental backup 408). Specifically, the blocks at (1,1) and (2,2) are overwritten with data D2. Also, the corresponding entries in the list 502 are flagged to indicate that the blocks at (1,1) and (2,2) have been overwritten. In the example of FIG. 5, an entry is flagged by changing the value of a corresponding bit (e.g., from one to zero).

The restore database 500 is next overwritten with the blocks from the incremental backup (incremental backup 404) immediately preceding the last incremental backup 408. Specifically, the blocks at (1,2), (1,3), and (3,1) are overwritten with data D1. Significantly, the block (2,2) is not overwritten even though that block is included in the incremental backup 404, because that block has already been overwritten once. In other words, only a block that is unflagged in the list 502 may be written to; because block (2,2) was flagged as described above, it cannot be written to. Thus, in this embodiment, a block can be overwritten only once during the restore operation.

After the incremental backup 404 is written to the restore database 500, the corresponding entries in the list 502 are flagged to indicate that the blocks at (1,2), (1,3), and (3,1) have been overwritten. Thus, in this example, all entries in the list 502 have been flagged. In this embodiment, the restore operation is complete when all entries in the list 502 have been flagged.

As can be seen from FIGS. 4 and 5, the final version 510 of the restore database 500 is identical to the state of the database 400 at time T2 (the restore time).

Importantly, in the restore operation just described, the incremental backups are utilized in reverse chronological order. That is, the order in which the incremental backups are utilized is opposite the order in which they were created. In the example of FIG. 4, the incremental backup 404 was created before the incremental backup 408, but during the restore operation, the incremental backup 408 was utilized before the incremental backup 404.

If the incremental backups were conventionally utilized in chronological order, then block (2,2) would have been overwritten when incremental backup 404 was written to the restore database, and that block would have been overwritten again when incremental backup 408 was written to the restore database. By instead utilizing the incremental backups in reverse chronological order, each block may be overwritten only a single time. Because repetitive writes to the same block are avoided, the amount of computational resources and time needed to accomplish the restore operation are reduced. Generally speaking, in embodiments according to the present invention, the restore operation can be performed quicker and more efficiently.

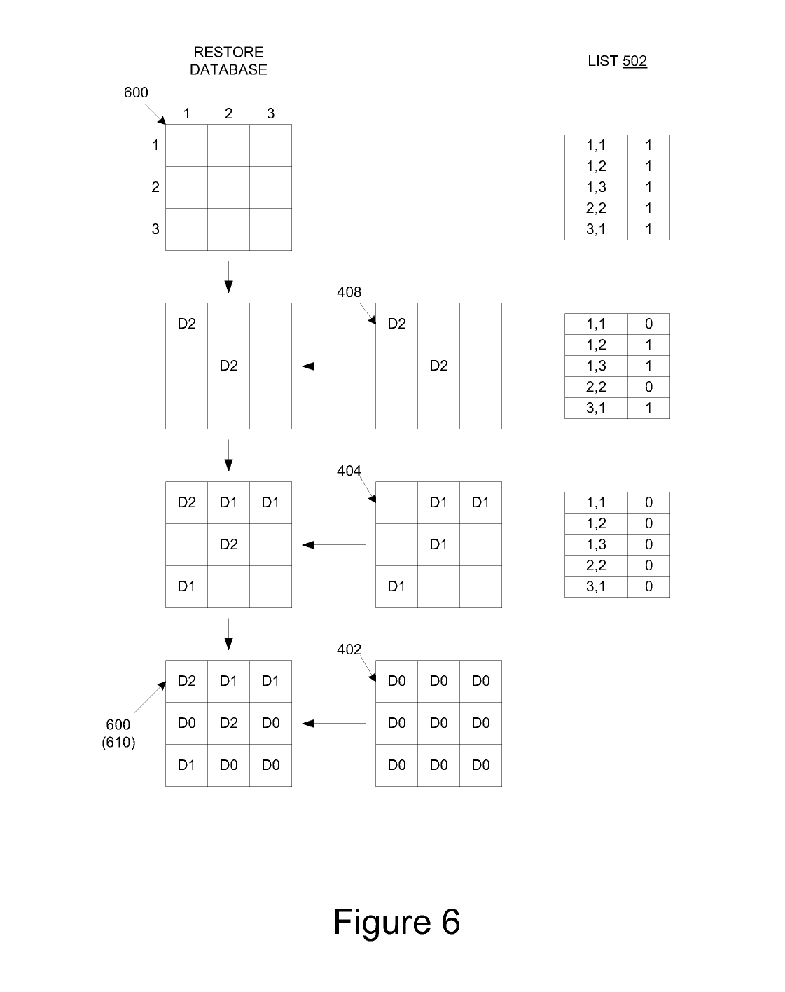

FIG. 6 illustrates an example of a process for restoring a database in another embodiment according to the present invention. In the example of FIG. 6, and with reference also to FIG. 4, the version of the database to be restored is the version 420 of the database 400 that existed at time T2.

In the embodiment of FIG. 6, the initial version of the restore database 600 is empty (in contrast to the embodiment of FIG. 5, in which the full backup 402 is used as the initial version of the restore database). As in the embodiment of FIG. 5, the set of incremental backups between the full backup 400, up to and including the incremental backup (e.g., the incremental backup 408) corresponding to the restore time (e.g., time T2), is retrieved, and a list 502 of blocks that changed between time T0 and the restore time is created.

In the example of FIG. 6, the initial version of the restore database 600 is first overwritten with the blocks from the last incremental backup (the incremental backup 408). Specifically, the blocks at (1,1) and (2,2) are overwritten with data D2. Also, the corresponding entries in the list 502 are flagged to indicate that the blocks at (1,1) and (2,2) have been overwritten.

The restore database 600 is next overwritten with the blocks from the incremental backup (incremental backup 404) immediately preceding the last incremental backup 408. Specifically, the blocks at (1,2), (1,3), and (3,1) are overwritten with data D1. Significantly, the block (2,2) is not overwritten even though that block is included in the incremental backup 404, because that block has already been overwritten once. That is, in this embodiment, a block can be overwritten only once during the restore operation.

Also, the corresponding entries in the list 502 are flagged to indicate that the blocks at (1,2), (1,3), and (3,1) have been overwritten. Thus, in this example, all entries in the list 502 have been flagged.

In this embodiment, once all entries in the list 502 have been flagged, the full backup 402 is used to fill in the remaining (empty) blocks in the restore database 600. Note that the list 502 can be used to identify the empty blocks in the restore database. That is, blocks in the list 502 are not empty, and conversely blocks that are not in the list 502 are empty.

As can be seen from the figures, the final version 610 of the restore database 600 is identical to the version 420 of the database 400 at time T2 (the restore time). Importantly, as in the embodiment of FIG. 5, the restore operation of FIG. 6 utilizes the incremental backups in reverse chronological order. By utilizing the incremental backups in reverse chronological order, each block may be overwritten only a single time. As such, the restore operation can be performed quicker and more efficiently.

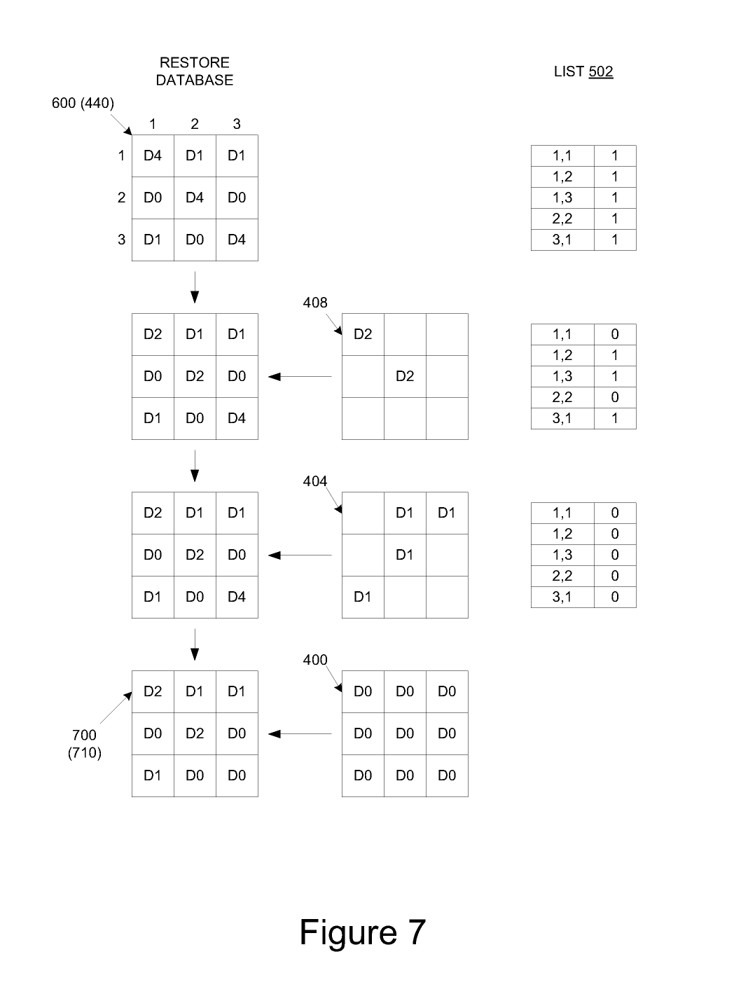

FIG. 7 illustrates an example of a process for restoring a database in yet another embodiment according to the present invention. In the example of FIG. 7, and with reference also to FIG. 4, the version of the database to be restored is the version 420 of the database 400 that existed at time T2.

In the embodiment of FIG. 7, the initial version of the restore database 700 is the most recent version of the active database 400 (e.g., the version at time T4; version 440). As in the embodiments of FIGS. 5 and 6, the set of incremental backups between the full backup 400, up to and including the incremental backup (e.g., the incremental backup 408) corresponding to the restore time (e.g., time T2), is retrieved, and a list 502 of blocks that changed between time T0 and the restore time is created.

In the example of FIG. 7, the active database 400 (the current version 440) is frozen at the beginning of the restore operation. In one embodiment, this is accomplished by performing a copy-only snapshot operation on the active database 400. The initial version of the restore database 700 is then overwritten with the blocks from the last incremental backup (the incremental backup 408). Specifically, the blocks at (1,1) and (2,2) are overwritten with data D2. Also, the corresponding entries in the list 502 are flagged to indicate that the blocks at (1,1) and (2,2) have been overwritten.

The restore database 700 is next overwritten with the blocks from the incremental backup (incremental backup 404) immediately preceding the last incremental backup 408. Specifically, the blocks at (1,2), (1,3), and (3,1) are overwritten with data D1. Significantly, the block (2,2) is not overwritten even though that block is included in the incremental backup 404, because that block has already been overwritten once. That is, in this embodiment, a block can be overwritten only once during the restore operation.

Also, the corresponding entries in the list 502 are flagged to indicate that the blocks at (1,2), (1,3), and (3,1) have been overwritten. Thus, in this example, all entries in the list 502 have been flagged.

In this embodiment, once all entries in the list 502 have been flagged, the full backup 402 is used to fill in the remaining (empty) blocks in the restore database 700, as in the embodiment of FIG. 6.

As can be seen from the figures, the final version 710 of the restore database 700 is identical to the version 420 of the database 400 at time T2 (the restore time). Importantly, as in the embodiments of FIGS. 5 and 6, the restore operation of FIG. 7 utilizes the incremental backups in reverse chronological order. By utilizing the incremental backups in reverse chronological order, each block may be overwritten only a single time. As such, the restore operation can be performed quicker and more efficiently.

FIGS. 8, 9, and 10 are flowcharts 800, 900, and 1000, respectively, of examples of computer-implemented processes for restoring a database according to embodiments of the present disclosure. The flowcharts 800, 900, and 1000 can be implemented as computer-executable instructions residing on some form of non-transitory computer-readable storage medium (e.g., using computing system 110 of FIG. 1). FIGS. 8, 9, and 10 correspond to the embodiments of FIGS. 5, 6, and 7, respectively.

In block 802 of FIG. 8, the point in time to which a database is to be restored (the restore time) is identified. Prior to that point in time, a full backup of the database was made, and incremental backups were also made after the full backup.

In block 804, the full backup is accessed and is used as the initial version of the restore database.

In block 806, a list of blocks in the database that changed between the full backup and the restore time is created.

In block 808, the series of 1, . . . , N incremental backups that were created between the full backup and the restore time is accessed and retrieved. According to embodiments of the present invention, the Nth incremental backup is the incremental backup corresponding to the restore time. The Nth incremental backup was created after the (N−1)th incremental backup was created. The Nth incremental backup corresponds to the last incremental backup in the set of retrieved incremental backups, as defined previously herein.

In block 810, blocks in the full backup are overwritten with blocks from the Mth incremental backup (initially, M=N).

In block 812, the list of changed blocks (from block 806) is updated to indicate which of those blocks were overwritten in block 810.

In block 814, if the list of changed blocks includes one or more unflagged entries (indicating that not all of the changed blocks have been overwritten during the restore operation), then the flowchart 800 proceeds back to block 810 and the value of M is reduced by one (M=M−1). In that case, the operations of blocks 810, 812, and 814 are repeated until all entries in the list of changed blocks are flagged. Note that it is not necessary for the value of M to be reduced to zero in order for the restore operation to end. Note also that M equal to zero corresponds to the full backup.

In block 816, if all entries in the list of changed blocks are flagged (per block 814), then the restore operation is complete.

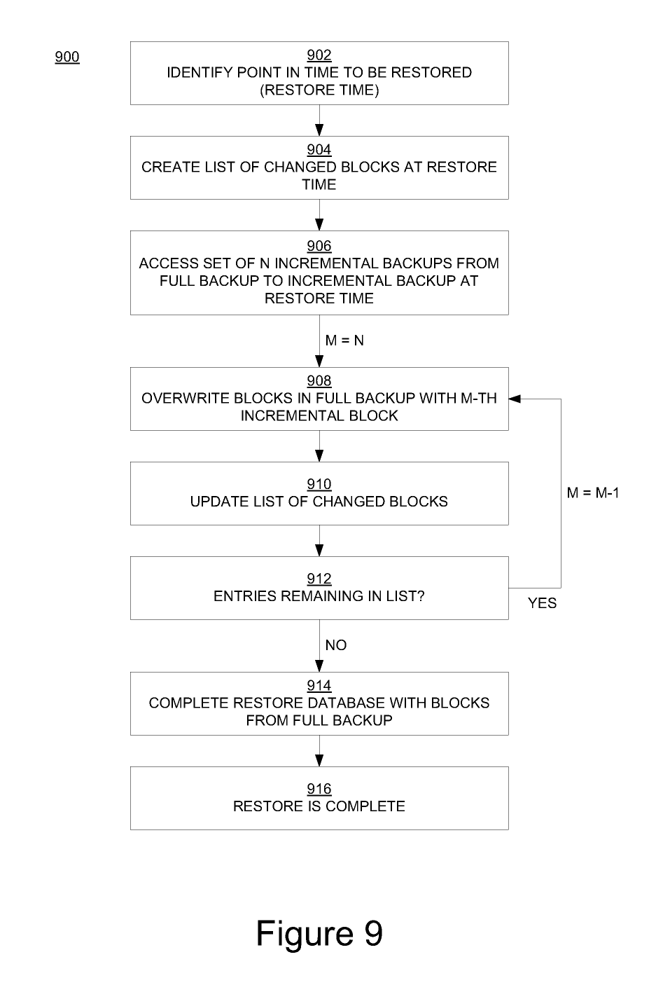

In block 902 of FIG. 9, the point in time to which a database is to be restored (the restore time) is identified. Prior to that point in time, a full backup of the database was made, and incremental backups were also made after the full backup.

In block 904, a list of blocks in the database that changed between the full backup and the restore time is created.

In block 906, the series of 1, . . . , N incremental backups that were created between the full backup and the restore time is accessed and retrieved. According to embodiments of the present invention, the Nth incremental backup is the incremental backup corresponding to the restore time. The Nth incremental backup was created after the (N−1)th incremental backup was created. The Nth incremental backup corresponds to the last incremental backup in the set of retrieved incremental backups, as defined previously herein.

In block 908, blocks in the full backup are overwritten with blocks from the Mth incremental backup (initially, M=N).

In block 910, the list of changed blocks (from block 904) is updated to indicate which of those blocks were overwritten in block 908.

In block 912, if the list of changed blocks includes one or more unflagged entries (indicating that not all of the changed blocks have been overwritten during the restore operation), then the flowchart 900 proceeds back to block 908 and the value of M is reduced by one (M=M−1). In that case, the operations of blocks 908, 910, and 912 are repeated until all entries in the list of changed blocks are flagged.

In block 914, if all entries in the list of changed blocks are flagged (per block 912), then the restore database is completed with blocks from the full backup as described above in conjunction with FIG. 6.

In block 916 of FIG. 9, the restore operation is complete.

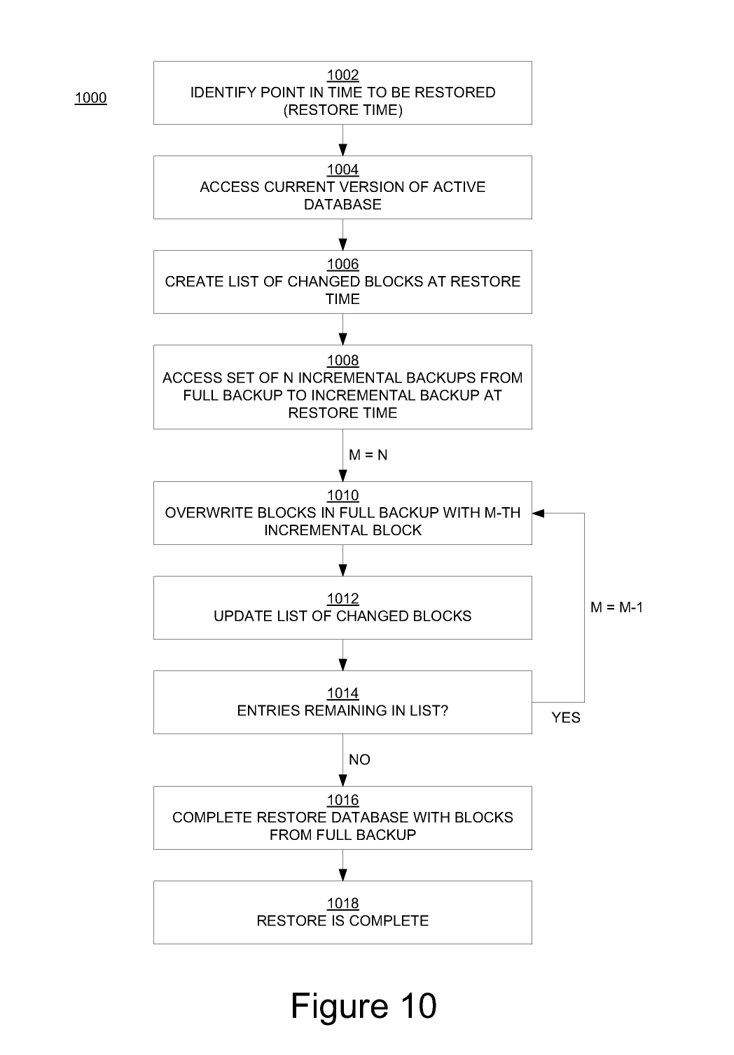

In block 1002 of FIG. 10, the point in time to which an active database is to be restored (the restore time) is identified. Prior to that point in time, a full backup of the database was made, and incremental backups were also made after the full backup.

In block 1004, the active database is frozen in its current state, using a copy-only snapshot operation, for example.

In block 1006, a list of blocks in the database that changed between the full backup and the restore time is created.

In block 1008, the series of 1, . . . , N incremental backups that were created between the full backup and the restore time is accessed and retrieved. According to embodiments of the present invention, the Nth incremental backup is the incremental backup corresponding to the restore time. The Nth incremental backup was created after the (N−1)th incremental backup was created. The Nth incremental backup corresponds to the last incremental backup in the set of retrieved incremental backups, as defined previously herein.

In block 1010, blocks in the full backup are overwritten with blocks from the Mth incremental backup (initially, M=N).

In block 1012, the list of changed blocks (from block 1006) is updated to indicate which of those blocks were overwritten in block 1010.

In block 1014, if the list of changed blocks includes one or more unflagged entries (indicating that not all of the changed blocks have been overwritten during the restore operation), then the flowchart 1000 proceeds back to block 908 and the value of M is reduced by one (M=M−1). In that case, the operations of blocks 1010, 1012, and 1014 are repeated until all entries in the list of changed blocks are flagged.

In block 1016, if all entries in the list of changed blocks are flagged (per block 1014), then the restore database is completed with blocks from the full backup as described above in conjunction with FIG. 7.

In block 1018 of FIG. 10, the restore operation is complete.

In summary, embodiments according to the present disclosure restore a database by working through incremental backups in reverse chronological order (in the order opposite that in which they were created). Consequently, the amount of computational resources and time needed to accomplish a restore operation can be reduced. Generally speaking, according to embodiments described herein, a restore operation can be performed quicker and more efficiently.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

1. A non-transitory computer-readable storage medium having computer-executable instructions that, when executed, cause a computer system to perform a method comprising:
restoring a database to a state at a second point in time after a full backup was created at a first point in time, said restoring comprising:
accessing plurality of incremental backups comprising an incremental backup that corresponds to said second point in time and incremental backups created between said first and second points in time; and
selectively overwriting blocks in said full backup with corresponding blocks from said plurality of incremental backups, starting with said incremental backup that corresponds to said second point in time and continuing through said plurality of incremental backups in reverse chronological order,
wherein the overwriting does not depend on a computation of a transaction on the database.

2. The computer-readable storage medium of claim 1 wherein blocks are overwritten only a single time during said restoring, wherein further said overwriting terminates when all blocks in said full backup that changed between said full backup and said incremental backup are overwritten once.

3. The computer-readable storage medium of claim 1 wherein said method further comprises storing change maps for said plurality of incremental backups, wherein a change map indicates blocks that are stored in a corresponding incremental backup.

4. The computer-readable storage medium of claim 1 wherein said method further comprises tracking blocks that are different between said full backup and said incremental backup and that are overwritten during said restoring.

5. The computer-readable storage medium of claim 1 wherein said restoring further comprises:
generating a list of blocks that are different between said full backup and said incremental backup; and
flagging an entry in said list when a block of said full backup corresponding to said entry is overwritten, wherein said overwriting continues until all entries in said list are flagged.

6. The computer-readable storage medium of claim 1 wherein said restoring further comprises initiating an incremental backup process prior to said accessing to create a change map that identifies changes to said database since the preceding incremental backup, wherein said incremental backup process is terminated when said change map is created.

7. The computer readable storage medium of claim 1 wherein said database comprises a Structured Query Language database.

8. A system comprising:
a processor;
a communication interface coupled to said processor; and
memory coupled to said processor and having stored therein instructions that, if executed by said system, cause said system to perform operations comprising:
restoring a database to a state at a point in time after a full backup of said database was created, said restoring comprising:
accessing a plurality of incremental backups of said database created at points in time after said full backup was created, said plurality of incremental backups comprising an incremental backup that corresponds to said point in time and incremental backups created between creation of said full backup and said point in time;
selectively writing blocks from said plurality of incremental backups to a restore database, starting with said incremental backup that corresponds to said point in time and continuing through said second plurality of incremental backups in reverse chronological order; and
writing blocks from said full backup to corresponding empty blocks in said restore database,
wherein the writing does not depend on a computation of a transaction on the database.

9. The system of claim 8 wherein said restoring continues until all incremental backups in said plurality are written to said restore database, wherein blocks in said restore database are written to only a single time during said restoring.

10. The system of claim 8 wherein said operations further comprise storing change maps for said plurality of incremental backups, wherein a change map indicates blocks that are stored in a corresponding incremental backup.

11. The system of claim 8 wherein said operations further comprise tracking blocks that changed between said full backup and said incremental backup and that are written to during said restoring.

12. The system of claim 8 wherein said restoring further comprises:
generating a list of blocks that changed between said full backup and said incremental backup; and
flagging an entry in said list when a block of said full backup corresponding to said entry is overwritten.

13. The system of claim 8 wherein said database comprises a Structured Query Language database.

14. A computer-implemented method of restoring data, said method comprising:
creating a first plurality of incremental backups of said active database at points in time after a full backup was created at a first point in time; and
at a third point in time, restoring said active database to a state at a second point in time between said first and third points in time, said restoring comprising:
accessing a second plurality of said incremental backups comprising an incremental backup that corresponds to said second point in time and incremental backups created between said first and second points in time;
selectively overwriting blocks in said active database from said third point in time with corresponding blocks from said second plurality of incremental backups, starting with said incremental backup that corresponds to said second point in time and continuing through said second plurality of incremental backups in reverse chronological order; and
writing blocks from said full backup to corresponding blocks in said active database that were not overwritten with blocks from said second plurality of incremental backups,
wherein the overwriting does not depend on a computation of a transaction on the database.

15. The method of claim 14 wherein blocks are overwritten only a single time during said restoring, wherein further said overwriting terminates when all blocks in said full backup that changed between said first and second points in time are overwritten once.

16. The method of claim 14 further comprising storing change maps for said first plurality of incremental backups, wherein a change map indicates blocks that are stored in a corresponding incremental backup.

17. The method of claim 14 further comprising tracking blocks that changed between said first and third points in time and that are overwritten during said restoring.

18. The method of claim 14 wherein said restoring further comprises:
generating a list of blocks that changed between said first and third points in time; and
flagging an entry in said list when a block of said active database from said third point in time is overwritten, wherein said overwriting continues until all entries in said list are flagged.

19. The method of claim 14 wherein said restoring further comprises freezing said active database at said third point in time until said overwriting begins.

20. The method of claim 14 wherein said database comprises a Structured Query Language database.
